(19) United States
(12) Patent Application Publication
(10) Pub. No.: US 2007/0076019 A1
(43) Pub. Date: Apr. 5, 2007

(54) Modulating images for display

(76) Inventor: Martin J. Randall, Santa Cruz, CA (US)

Correspondence Address: TROP PRUNER & HU, PC, 1616 S. VOSS ROAD, SUITE 750, HOUSTON, TX, 77057-2631, US

(21) Appl. No.: 11/240,699

(22) Filed: Sep. 30, 2005

(51) Int. Cl. G09G 5/10

(52) U.S. Cl. 345/691

(57) ABSTRACT

A display may be implemented with a pulse width modulated system in which the number of pulse width modulated slots may be divided up across the frame using less than the full number of available pulse width modulated slots per color. In addition, within any given field time, the pixels may be operated on in slots spread relatively evenly across the entire field time in some embodiments. In one embodiment, a spatial light modulator directly controls the pixel values at a pulse width modulated slot.

### BACKGROUND

This invention relates generally to spatial light modulator displays.

A projection display system typically includes one or more spatial light modulators (SLMs) that modulate light for purposes of producing a projected image. The SLM may include, for example, a liquid crystal display (LCD) such as a high temperature polysilicon (HTPS) LCD panel or a liquid crystal on silicon (LCOS) microdisplay, a grating light valve or a MEMs (where “MEMs” stands for micro-electro-mechanical devices) light modulator such as a digital mirror display (DMD) to modulate light that originates from a lamp of the projection display system. In typical projection display systems, the lamp output is formatted with optics to deliver a uniform illumination level on the surface of the SLM. The SLM forms a pictorial image by modulating the illumination into spatially distinct tones ranging from dark to bright based on supplied video data. Additional optics then relay and magnify the modulated illumination pattern onto a screen for viewing.

In order to obtain high quality images, relatively high clock rates may be desirable. However, such high clock rates complicate the design of the components needed to achieve that clock rate. In addition, the cost of the display system may increase significantly. If that were not problem enough, the power consumption may become excessive.

### BRIEF DESCRIPTION OF THE DRAWINGS

FIG. 1 is a schematic diagram of a projection display system according to an embodiment of the invention;

FIG. 2 is a block diagram of an electrical system of the projection display system according to an embodiment of the invention;

FIG. 3 is an illustration of a pulse width modulation control technique for a pixel cell according to an embodiment of the invention;

FIG. 4 depicts relationships between pixel intensities and a table index value;

FIG. 5 is a color sequence for one embodiment of the present invention;

FIG. 6 is a flow chart of one embodiment of the present invention;

FIG. 7 is a color sequence for one embodiment of the present invention;

FIG. 8 is a color sequence for one embodiment of the present invention; and

FIG. 9 is a flow chart of one embodiment of the present invention.

### DETAILED DESCRIPTION

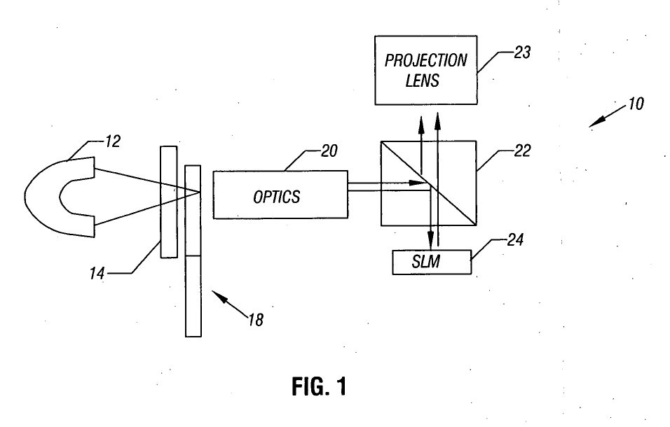

Referring to FIG. 1, a projection display system 10, in accordance with an embodiment of the invention, includes one or more spatial light modulators (SLMS) 24 (one shown in FIG. 1) that modulate impinging light to produce a projected composite, color optical image (herein called “the projected image”). The SLM 24 may be either a liquid crystal (LC) SLM, a tilt-mirror SLM, or a MEMs type SLM, depending on the particular embodiment of the invention.

Unless otherwise stated, embodiments described herein use LC SLMs for purposes of simplifying the description. However, it is understood that other SLMs, such as grating light valve, HTPS, or other technology SLMs, may be used, in other embodiments of the invention. Furthermore, unless otherwise noted below, the projection display system 10 includes a single SLM 24, for purposes of simplifying the following description, although other projection systems that have multiple SLMs may be alternatively used and are within the scope of the appended claims.

The SLM 24 typically includes an array of pixel cells, each of which is electrically controllable to establish the intensity of a pixel of the projected image. In some projection display systems, SLMs are transmissive and in others, they are reflective. For the purposes of simplification, the discussion will address reflective SLMs.

An SLM may be operated so that each pixel has only two states: a default reflective state which causes either a bright or a dark projected pixel and a non-default reflective state which causes the opposite projected pixel intensity. In the case of a liquid crystal on silicon (LCOS) SLM, the pre-alignment orientation of the LC material and any retarders in the system determine whether the default reflective state is normally bright or normally dark.

For the purposes of simplification, the discussion will denote the default reflective state as normally bright, i.e., one in which the pixel cell reflects incident light into the projection lens (the light that forms the projected image) to form a corresponding bright pixel of the projected image. Thus, in its basic operation, the pixel cell may be digitally-controlled to form either a dark pixel (in its non-default reflective state) or a bright pixel (in its default reflective state). In the case of a digital light projector (DLP) SLM, the states may represent the pixel in a co-planar position to the underlying substrate.

Although its pixels are operated digitally, the SLM 24 may also be used in an application to produce visually perceived pixel intensities (called “gray scale intensities”) between the dark and bright levels. For such an application, each pixel may be controlled by pulse width modulation (PWM), a control scheme that causes the human eye to perceive gray scale intensities in the projected image, although each pixel cell still only assumes one of two states at any one time. The human visual system perceives a temporal average of pixel intensity when the PWM control operates at sufficiently fast rates.

In the PWM control scheme, a pixel intensity (or tone) is established by controlling the time that the pixel cell stays in its reflective state and the time that the pixel cell remains in the non-reflective state during an interval time called a PWM cycle. This type of control is also referred to as duty cycle control in that the duty cycle (the ratio of the time that the pixel cell is in its reflective state to the total time the pixel cell is in its non-reflective and reflective states) of each PWM cycle is controlled to set the pixel intensity. A relatively bright pixel intensity is created by having the pixel cell spend a predominant proportion of time in its reflective state during the PWM cycle, while a relatively dark pixel intensity is created by having the pixel cell spend a predominant amount of time in its non-reflective state during the PWM cycle.

The quality of the projected image typically is a function of the number of possible gray scale intensities, also called the “bit depth.” For the above-described PWM control scheme, a bit depth of “N” means that the PWM cycle is divided into 2^{N} time consecutive and non-overlapping time segments. For a particular PWM cycle, each of the time segments in which the pixel cell is in its reflective state contributes to the overall luminance of the corresponding pixel. Each time segment of the PWM cycle typically corresponds in duration to the cycle of a clock signal. Thus, the larger the number of time segments (i.e., the greater the number of gray scale intensities), the higher the frequency of this clock signal, thereby requiring a high speed clock to form the pixel gray scale or tonal range. Power consumption is also a function of this clock frequency and also increases with bit depth.

Other factors may increase the clock rate needed for a particular bit depth. For example, for a three SLM LCD panel projection system (one SLM for each primary color), the PWM cycle may have a period that is equal to one half of the video data's field time (typically 1/60 second). Opposite drive voltage polarities are needed in LCD systems to prevent voltage bias accumulation. This is well known for liquid crystal display systems. Thus, LCD SLM devices require two PWM cycles in each video data field. This doubles the clock rate requirement.

For a two SLM panel projection system where one of the SLM panels is temporally shared by two primary colors, the video frame time must be split to allocate PWM cycles to each primary color, thereby increasing the needed PWM clock rate if the same bit depth is maintained in all colors.

For a one SLM panel projection system with an SLM panel temporally shared by all three primary colors, the video frame time must be further subdivided. For an LCOS SLM the video frame time would be divided into six PWM cycles, a pair for each primary color. The PWM clock period may have an even shorter duration when the unequal length PWM cycles are needed to adjust the display white point. Since common projection lamps are rich in blue and weak in red output, it is generally necessary to devote longer portions of the video frame time to red to achieve white balance. This necessitates the PWM clock period to be increasingly small and the clock frequency and power consumption to be increasingly high.

In accordance with some embodiments of the invention, the projection display system 10 includes a lamp 12 (a mercury lamp, for example) that produces a broad visible spectrum illumination beam that passes through an ultraviolet/infrared (UV/IR) filter 14 of the system 10. The light passing from the filter 14, in turn, passes through a rotating color wheel.

A function of the color wheel 18 is to serve as a time-varying wavelength filter to allow certain wavelengths of light to pass therethrough at the appropriate times so that the filtered light may be modulated by the SLM 24 to produce the projected image. More specifically, in some embodiments of the invention, the projection display system 10 may be a shared color system, a system in which, for example, the SLM 24 modulates red, followed by green, followed by blue light. Thus, the SLM 24 is temporally shared to modulate different primary color beams.

As previously stated, the single-SLM configuration that is depicted in FIG. 1 is for purposes of example only. Thus, the projection display system 10 may be replaced by another projection display system, in other embodiments of the invention, such as a projection display system that includes three SLMs, one for each primary color (red, green and blue, for example) of the projected image. As another example, in some embodiments of the invention, red, green and blue light may be temporally shared on an SLM in a two SLM display projection system. Therefore, many variations are possible and are within the scope of the appended claims.

Among its other components, the projection display system 10 includes homogenizing and beam shaping optics 20 that further shape and collimate the light that exits the color wheel 18, prepolarizes and directs the resultant beam to the polarizing beam splitter 22. The polarizing beam splitter (PBS) 22 separates the light from the color wheel 18 based on polarization. More specifically, assuming the single-SLM configuration described above, the polarizing beam splitter 22 directs the different color sub-bands of light (at different times) to the SLM 24. Once modulated by the SLMs 24, the polarizing beam splitter 22 directs the modulated beam through projection lenses 23 for purposes of forming the projected image.

Depending on the particular embodiment of the invention, the SLM 24 may be a digital mirror device (DMD), liquid crystal display (LCD) device, or other pixelated SLM. In some embodiments of the invention, the SLM 24 is a liquid crystal on silicon (LCOS) device that includes a liquid crystal layer that is formed on a silicon substrate in which circuitry (decoders, control circuits and registers, for example) to control and operate the device is fabricated.

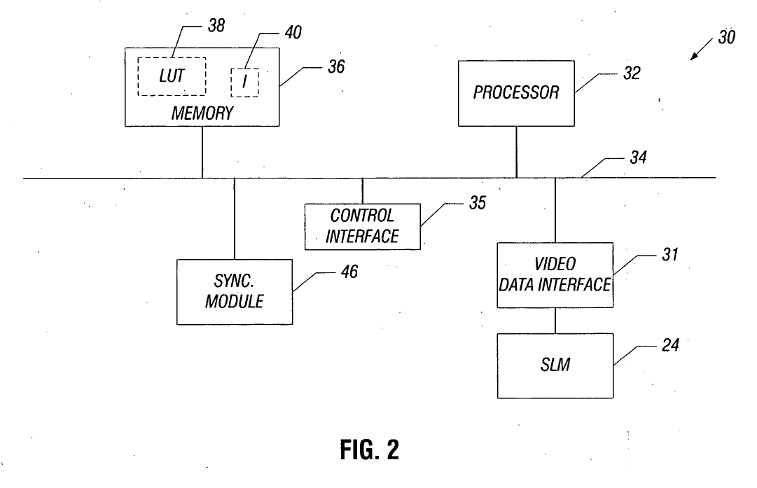

In some embodiments of the invention, an electrical system 30 for the projection display system 10 (FIG. 1) may have a general structure that is depicted in FIG. 2. Referring to FIG. 2, the electrical system 30 may include a processor 32 (one or more microcontrollers or microprocessors, as examples) that is coupled to a system bus 34. The processor 32 communicates over the system bus 34 with a memory 36 (a flash memory, for example) of the electrical system 30. The memory 36 stores instructions 40 to cause the processor 32 to perform one or more of the techniques that are described herein, as well as a look-up table (LUT) 38.

In some embodiments, the projection display system 10 (FIG. 1) operates the pixel cells of the SLM 24 in a digital fashion, in that each pixel cell at any one time is either in a reflective state or a non-reflective state. Gray scale intensities are achieved by pulse width modulation (PWM), a modulation technique that controls the optical behavior of the pixel cell during an interval of time called a PWM cycle to control the intensity of the corresponding pixel of the projected image. The PWM control regulates the amount of time that a particular pixel cell is in its reflective and non-reflective states during a PWM cycle for purposes of establishing a certain pixel intensity. The amount of time that the pixel cell is in each reflectivity state for a given pixel intensity value is established by the LUT 38, in some embodiments. It is noted that, in some embodiments, the LUT 38 may represent a collection of LUTs, one for each primary color. For purposes of simplifying the discussion herein, only one LUT is assumed, unless otherwise stated. The LUT 38 indicates a PWM duty cycle for each potential pixel intensity value.

Among its other features, the electrical system 30 may include a color wheel synchronization module 46 and a video data interface 31 that are coupled to the system bus 34. The color wheel synchronization module 46 can assist in ensuring that the physical position of the color wheel 18 is aligned with the start of a PWM timing cycle. The video data interface 31 receives pixel intensity data that is mapped through LUT 38 to specify per pixel PWM data (to drive the SLM 24).

In some embodiments, the LUT 38 includes a corresponding duty cycle entry for each unique pixel intensity value. The duty cycle entry indicates a duration that the pixel cell remains in its default reflective state during the PWM cycle to produce the desired pixel intensity. The pixel cell remains in the non-default reflective state during the remainder of the PWM cycle. In some embodiments of the invention, each table entry indicates a number of pulse width modulation (PWM) counts, or clock cycles, for each intensity value. These are the number of clock cycles that the pixel cell needs to remain in its default reflective state. For the remaining clock cycles of the PWM cycle (having a fixed duration, for example), the pixel cell is in its non-default reflective state. The PWM clock counts may be executed with the non-reflective portion first and the reflective portion second or with the reflective portion first and the non-reflective portion second. In other embodiments, fractions of the total reflective and non-reflective clock counts may be alternated during a PWM cycle. In any execution strategy, the LUT-prescribed time proportion remains consistent relative to the whole PWM cycle time.

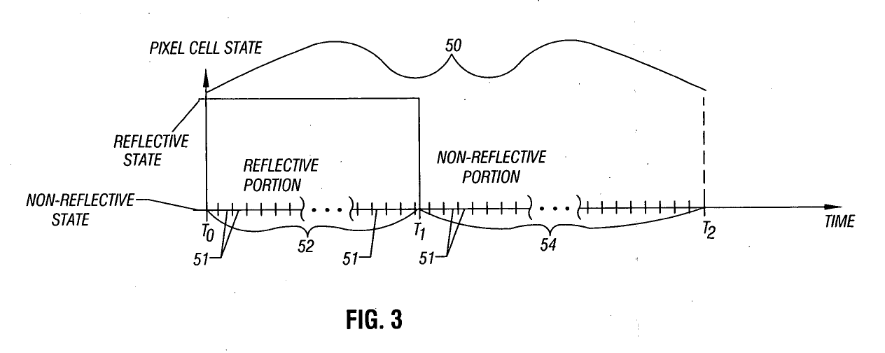

Referring to FIG. 2 in conjunction with FIG. 3, the processor 32, for a given video data value, retrieves the corresponding PWM count from the LUT 38. The retrieved value, in turn, determines the number of PWM clock counts that, in turn, govern the duration of a reflective portion 52 of a PWM cycle 50. The remaining counts form a non-reflective portion 54 (i.e., the remaining portion) of the PWM cycle 50. Stated differently, the PWM cycle 50 may be viewed as being formed from consecutive and non-overlapping time segments 51, each of which has the duration of a specified number of clock cycles. In some embodiments of the invention, the pixel cell, at the beginning of the PWM cycle 50, is in the non-reflective state. The number of PWM counts determine the number (if any) of time segments 51 from time T₀ until time T₁ (at the end of the reflective portion 52 of the PWM cycle 50) in which the pixel cell remains in the reflective state. At the conclusion (time T₁) of the reflective portion 52, the pixel cell transitions to its non-reflective state (to begin the non-reflective portion 54) until the end of the PWM cycle 50 at time T₂.

The duration of the PWM cycle 50 depends on the configuration of the projection display system. For the single liquid crystal SLM panel-configuration of the projection display system 10 (FIG. 1), the PWM cycle time is equal to a multiple of one sixth of the field time interval ( 1/60 seconds). The multiple may be set as desired to mitigate color breakup, a visual artifact associated with temporal color sequential displays. PWM cycle times may be at 1/240 Hz, 1/360 Hz, and so on. Each pair of PWM cycles is dedicated to an illumination color primary (red or green or blue). One PWM cycle asserts a first voltage polarity and the second PWM cycle asserts the opposite voltage polarity while driving the pixel cell to establish the pixel intensity (such as the PWM cycle 50). More specifically, the second PWM cycle should assert the bright state for the same duty cycle duration as the first PWM cycle, except that the voltage field across the liquid crystal material is reversed in polarity. Additionally, the reflectivity state sequence in the second PWM cycle may proceed in the reverse time order of the driving PWM cycle.

Using the retrieved value from the LUT 38, the processor 32, in accordance with some embodiments of the invention, utilizes the corresponding PWM count to time the duration of the PWM cycle for the respective pixel by means of the video data interface 31 (FIG. 2).

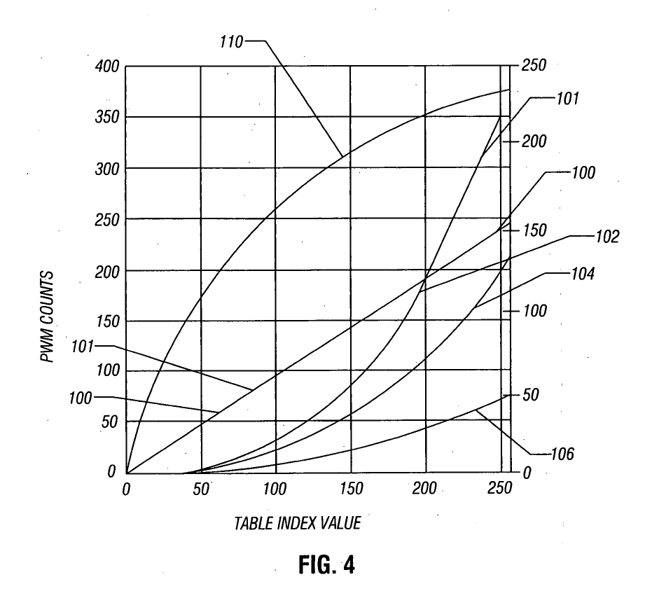

Referring to FIG. 3, in some embodiments, the entries of the LUT 38 (FIG. 2) establish a relationship between the PWM counts and the received video data values (represented by “table index values” in FIG. 4). For example, the LUT 38 establishes, in conjunction with other features of the display projection system 10 described below, relationships between the video data values and the pixel intensities that appear in the projected image. However, the video data that is furnished to the projection display system 10 may not have a linear relationship to the pixel intensities that are required for the projected image because the video data may be pre-compensated to drive a non-linear cathode ray tube (CRT) display, for example.

More specifically, the video data that is furnished to the projection display system 10 (FIG. 1) may be pre-compensated to accommodate the non-linear responses of phosphors of a CRT display. Thus, a conventional CRT display receives the pre-compensated video data and directly drives the CRT tube with this data. However, for a SLM display system, such as the projection display system 10, the pre-compensation must be removed from the video data. Therefore, the relationship between the video data and the PWM counts should not be linear, but rather, should be non-linear in a manner that removes the CRT pre-compensation and applies gamma compensation appropriate for the SLM in the projection system. The correct gamma compensation required will depend on the voltage to reflectance transfer characteristics of the SLM as well as the application. For office displays, it is common to drive to a final optical gamma of 2.2, while for home theater, it is more common to drive to a final optical gamma of 2.5.

More specifically, still referring to FIG. 4, system 10 may establish a non-linear relationship between the video data that is furnished to the system 10 and the PWM clock counts. A curve 106, for example, represents the needed relationship imposed by the LUT 38 between the blue component video data and the blue SLM PWM count; a curve 104 represents the needed relationship between the green component video data and the green SLM PWM count; and a curve 102 represents the needed relationship between the red component video data and the red SLM PWM count.

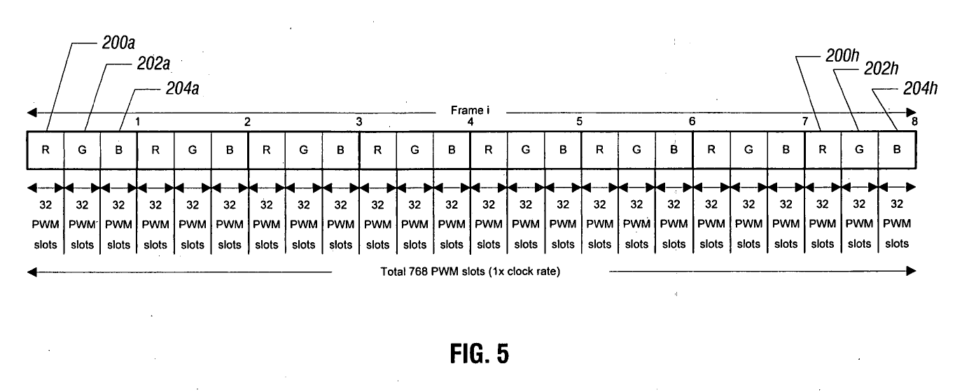

Referring to FIG. 5, a frame i may be made up of a number of subframes, such as eight as depicted, of each of three primary colors. A sub-frame corresponds to the three colors (red (R), green (G), and blue (B)). Thus, eight red fields 200a to 200h may be used together with eight green fields 202a to 202h and eight blue fields 204a to 204h. The first three fields 200a, 202a, and 204a may contain the more significant bit information. Prior to the receipt of the second set of fields 200b, 202b, and 204b, it may be assumed that their values are zero.

In FIG. 5, an eight-bit system is illustrated in which each pixel can have a value of zero to 255. A pixel value of zero causes the pixel to be off for the PWM slots. Conversely, a pixel value of 255 causes it to be on in 255 of the 256 slots or, in some embodiments, in all 256 slots. Then, a pixel value of 128 causes a pixel to be on for 128 of the 256 slots, exactly half of the time. In accordance with one embodiment of the present invention, 256 PWM time slots may be utilized, but they may be distributed over the frame i in a different way. Of course, the present invention is not limited to any number of slots or to an eight-bit pixel value.

Instead of repeating the entire PWM sequence each time, in some embodiments of-the present invention,-only a portion of the PWM sequence is displayed in each sub-field. The total time that the red, green, and blue pixel components are on may be identical to the conventional approach in some embodiments. However, in some embodiments, the pixel display is distributed across the entire frame display time which, in one embodiment, may be 1/60 of a second.

For example, with a conventional display system that uses 256 PWM slots per color, a frame rate of eight sub-frames may be shown per 60 Hz frame time. The display time for each color component in the sequence, assuming all the colors are given the same amount of time, is 1/60 of a second divided by eight, for the eight sub-frames, divided by three, for the three colors. Then, the effective frame rate is 480 Hz and the color field rate is three times the 480 Hz.

With one embodiment, the 256 PWM slots are divided across the entire field time. Then, only ⅛ of the PWM slots, in one example, are displayed in each field. That is, only 32 PWM slots are displayed per field, instead of 256 slots per field.

The total time that each pixel is on in a 60 Hz field may be identical to the prior techniques. The display of each color is simply parceled out differently across the total frame time.

By ensuring that the color on time for each component is subdivided fairly evenly across all the eight fields, the eye perceives a continuous display of the color components. By only displaying 32 PWM slots per field instead of 256, the data bandwidth and the clock frequencies used to support the display are reduced by eight, while achieving the same visual effect. In general, the number of PWM slots per color field may be equal to 2^{N} divided by the number of sub-frames where N is the bit depth. In contrast, with the prior art, the number of PWM slots per color field is 2^{N}. Obviously, this approach may substantially simplify the hardware and logic design.

The way in which the image is subdivided across the field time may ensure that the total pixel value is divided as evenly as possible between all of the color fields within the frame. For example, a pixel value of eight may be divided such that the pixel is on for one PWM slot in each of the eight color fields within the frame. The pixel value of 32 may be divided such that the pixel is on for four PWM slots per color field. One eighth of the value of the pixel is displayed in each of the eight color fields. There may be slight variations for pixel values that are not exactly divisible by eight, but provided the variations between color fields are minimized, the eye will not be able to detect the variation at such a high field rate. The eye integrates the color value over the entire field time.

Still higher field rates may be achieved by subdividing the frame into higher numbers of smaller sub-frames, each displaying a fewer number of PWM slots. For example, instead of eight sub-frames, 32 sub-frames may be displayed every frame time, with each sub-frame displaying eight of the 256 PWM slots. This gives an effective frame rate of 1920 Hz, essentially eliminating all color breakup artifacts without increasing the data rates or clock frequencies used.

Color breakup artifacts may be eliminated or reduced, in some embodiments, by displaying an extremely high effective frame rate without increasing the requirements for clock rate or data bandwidth. This may allow high quality displays to be designed without requiring high performance silicon cable running at extremely high clock rates, in some embodiments. It also allows displays that utilize this technique to effectively eliminate the undesirable color breakup artifacts visible in some systems. Finally, some embodiments may allow higher display resolution displays to be built since the bandwidth requirements are reduced.

As shown in FIG. 5, the red, green, and blue sequence is repeated eight times in one embodiment. However, rather than displaying all 256 PWM slots in every color field, ⅛ of the PWM slots are displayed in each of eight color fields for each of the three color components. In this example, the 256 PWM slots per color are divided equally between the eight color fields for each color. The total number of PWM slots per color is then equal to that in existing systems, but by displaying the PWM slots in a subdivided sequence, the color breakup artifacts are reduced. Then, the data rate is no higher than in the conventional systems and the clock rate remains at the same level. By subdividing the color fields into smaller and smaller components, and displaying smaller numbers of PWM slots per color field, the number of color fields per frame can be increased without increasing the data rate or the clock rate.

Thus, in some embodiments, less than the full number (2^{N}) of available PWM slots can be used per sub-frame per color. Then, it is no longer necessary to increase the frame rate and correspondingly increase the number of slots in the field time.

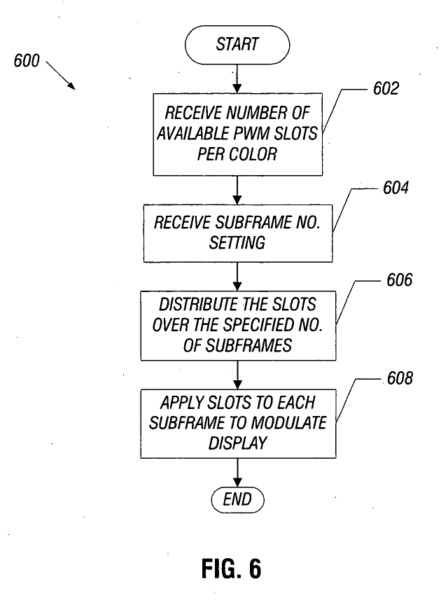

In accordance with one embodiment, a process 600, shown in FIG. 6, may implement a display system. The process 600 may be embodied in software, hardware, or firmware. For example, the process 600 may be implemented as software stored at 40, in connection with the memory 36, in one embodiment of the present invention.

Initially, the number of available PWM slots per color is received as indicated in block 602. Then, the number of sub-frames is received as indicated in block 604. Next, in block 606, the PWM slots are distributed over the specified number of sub-frames, for example, using the LUT 38 in one embodiment. Finally, the PWM slots are applied to each sub-frame to modulate the display (block 608).

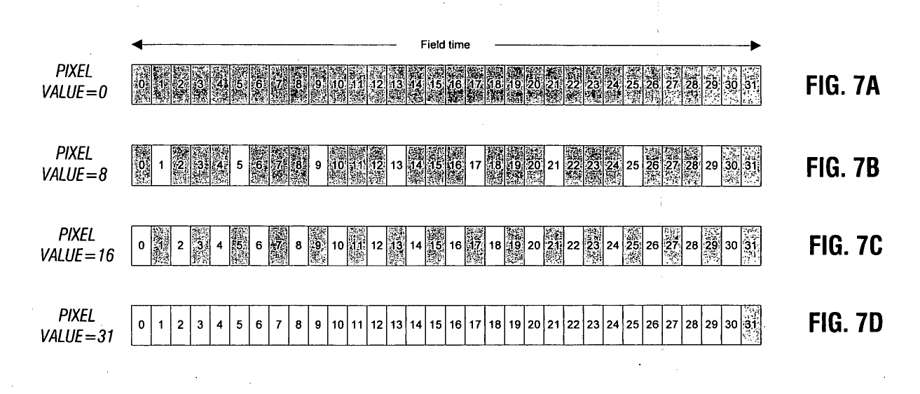

Referring to FIG. 7, a pixel color can have a range of possible values from zero to 31. A field is divided into 32 PWM slots and a pixel is turned on for the number of PWM slots corresponding to the value of the pixel.

FIG. 7A shows a representation of the field time for a pixel value equal to zero, where all the pixels across the field time are off. FIG. 7B shows a representation for the pixel value equal to eight out of 32 so that a pixel is on one-fourth of the field time. Thus, the pixel is on at 1, 5, 9, 13, 17, 21, 25, and 29 and, otherwise, the pixel is off. Next, a pixel value of 16 is indicated where the pixel is on half the field time as shown in FIG. 7C. Finally, a pixel value of 31 is shown in FIG. 7D where it is on all of the time, except for one instance.

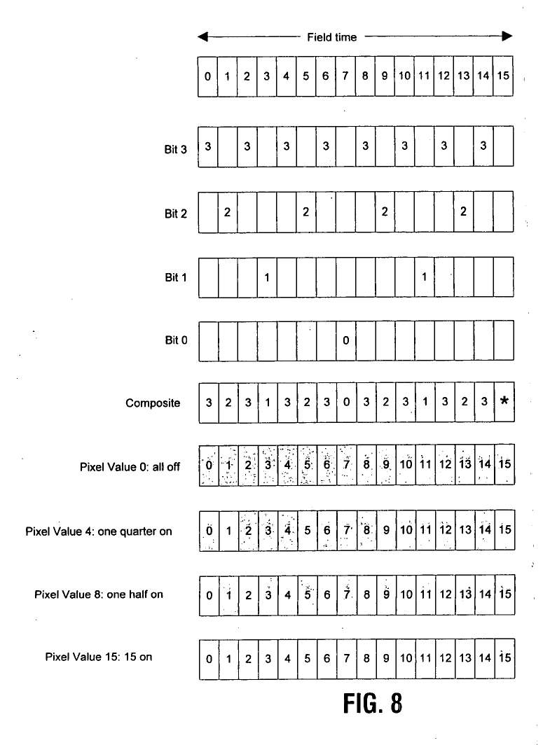

Referring to FIG. 8, the pixel value directly controls the pixel value (on or off) in each PWM slot. With a four bit per color example, for the sake of simplicity, a pixel color is represented by a four bit value ranging from zero to 15. In binary, this means the value ranges from 0000 to 1111. The control of the 16 PWM slots is assigned to the four bits of the pixel value. Bit three, the most significant bit of the four bits, controls the state of the PWM slots 0, 2, 4, 6, 8, 10, 12, and 14. Bit two controls the state of the PWM slots 1, 5, 9, and 13. Bit one controls the state of the PWM slots three and eleven. Bit zero controls the state of PWM slot seven. The composite sequence is then 3-2-3-1-3-2-3-0-3-2-3-1-3-2-3-0.

The pixels are turned on for exactly the correct number of PWM slots. For example, the pixel value four (binary 0100) has bit two with a value of one and bits three, one, and zero with a value of zero. This causes the pixel to be turned on in PWM slots 1, 5, 9, and 13, exactly four of the PWM slots distributed evenly throughout the field. The pixel value of eight (binary 1000) has bit three with a value of one and bits two, one, and zero with a value of zero. This causes the pixel to be turned on in the PWM slots 0, 2, 4, 6, 8, 10, 12, and 14—exactly eight of the PWM slots, distributed evenly throughout the field. A pixel value of 15 (binary 1111) causes the pixel to be turned on and PWM slots 0 through 14. Slot 15 is a special slot that can be optionally used to provide the means to turn the pixel on and all 16 of the slots as mentioned earlier. The PWM slot would only be turned on if the pixel color value is 15.

In a more complex system, for example, one having eight or more bits per pixel, the same scheme can be utilized to assign the eight bits to directly control the PWM slots. The most significant bit controls half the slots, evenly distributed. The next bit controls one-quarter of the slots, and so on.

This technique is particularly well suited for use in a system where the total color field of 256 PWM slots is subdivided into some number of subfields, as described above in connection with FIGS. 1-6, in order to reduce undesirable color breakup artifacts. Since the color value is evenly distributed across the total field, it is easy to divide the field into subfields without placing too many of the pixels “on” slots in one subfield and then in the other as might be the case in conventional modulation techniques in which all the PWM slots that are turned on are grouped together. This would be more likely to result in a perceptible flicker and the return of the undesirable color breakup artifacts at low pixel values.

In some embodiments, image quality on displays such as television or computer monitors using digital frame rate modulation may be improved. The modulation scheme may also be incorporated into televisions and computer monitors to control the display of the image.

Instead of grouping all the on-times into a single wide pulse of some number of PWM slots, the on-time is spread across the entire color field. As pixel response times become faster and faster, the present techniques become more and more applicable.

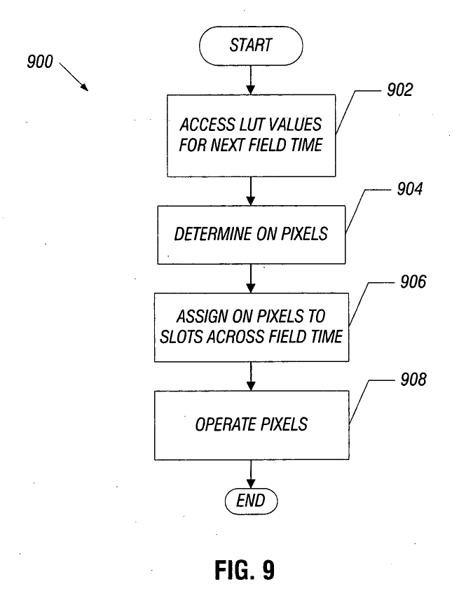

Thus, referring to FIG. 9, the process 900 may be implemented in software, hardware, or firmware. Again, it may be implemented as part of the code stored in the memory 40 and indicated as I in one embodiment. Initially, as indicated in block 902, the LUT values are accessed from the next field time. The on pixels are determined in block 904. The on pixels are assigned to the slots across the field time as indicated in block 906. Finally, the pixels are operated as indicated in block 908.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
displaying an image using less than 2^{N} pulse width modulated slots per color per sub-frame, where N is the bit depth.

2. The method of claim 1 including determining a number of available pulse width modulated slots per color.

3. The method of claim 2 including setting a number of sub-frames.

4. The method of claim 3 including distributing the pulse width modulated slots over a specified number of sub-frames.

5. The method of claim 1 including displaying 2^{N} slots divided by the number of sub-frames.

6. The method of claim 1 including using at least 32 sub-frames every 1/60 of a second to produce an effective frame rate of at least 1920 Hertz.

7. The method of claim 1 including dividing the total pixel value as evenly as possible between all the color fields within a frame.

8. The method of claim 1 including determining the number of on pixels for each field time.

9. The method of claim 8 including assigning the on pixels to the slots across the field time.

10. The method of claim 9 including turning a pixel on for exactly the correct number of pulse width modulated slots.

11. A control for a display, said control comprising:
a processor; and
a spatial light modulator, said spatial light modulator to directly control the pixel value in a pulse width modulated slot.

12. The control of claim 11 including a video data interface between said processor and said spatial light modulator.

13. The control of claim 11 including a control interface coupled to said processor.

14. The control of claim 13 including a memory storing a look up table to store the sequence of on and off pixel values.

15. The control of claim 14 including a synchronizer module to synchronize the operation of a color wheel.

16. The control of claim 11 wherein said modulator to display an image using less than 2^{N} pulse width modulated slots per color, per frame, where N is the bit depth.

17. The control of claim 11, said modulator to directly control the pixel value at the slot using a single bit of the 2^{N} pixel values where N is the bit depth.

18. A display system comprising:
projection optics;
a spatial light modulator; and
a control system including:
a processor; and
a spatial light modulator, said spatial light modulator to display an image using less than all of available pulse width modulated slots per color, per sub-frame.

19. The system of claim 18 including a video data interface between said processor and said spatial light modulator.

20. The system of claim 18 including a control interface coupled to said processor.

21. The system of claim 20 including a memory storing a look up table to store the sequence of on and off pixel values.

22. The system of claim 21 including a synchronizer module to synchronize the operation of a color wheel.

23. The system of claim 18, said modulator to display an image using less than 2^{N} pulse width modulated slots per color, per sub-frame.

24. The system of claim 23, said modulator to directly control the pixel value at a pulse width modulated slot using a single bit of 2^{N} pixel values where N is the bit depth.
